(19) United States
(12) Patent Application Publication
(10) Pub. No.: US 2009/0150612 A1
(43) Pub. Date: Jun. 11, 2009

(54) APPARATUS AND SYSTEM FOR DISPLAYING AN IMAGE IN CONJUNCTION WITH A REMOVABLE MEMORY CARTRIDGE

(76) Inventors: Rita Cooper, Alameda, CA (US); Leonard L. Hofheins, Walnut Creek, CA (US)

Correspondence Address: Kunzler & McKenzie, 8 EAST BROADWAY, SUITE 600, SALT LAKE CITY, UT, 84111, US

(21) Appl. No.: 12/372,623

(22) Filed: Feb. 17, 2009

Related U.S. Application Data
(63) Continuation of application No. 11/278,780, filed on Apr. 5, 2006.

(51) Int. Cl. G06F 12/02

(52) U.S. Cl. 711/115; 711/E12.008

(57) ABSTRACT

An apparatus and system are disclosed for displaying an image in conjunction with a removable memory cartridge. In one embodiment, the apparatus includes a housing that encloses a memory device for storing content data and a protrusion extending from the housing, the protrusion configured to display an image. The apparatus may further comprise an interface to connect the memory device to a base unit. In one embodiment, the content data is an audible message. In addition, the displayed image on the protrusion may be related to the content data stored on the memory device. For example, the displayed image may be an illustration related to an audible story stored on the memory device. In a further embodiment, the protrusion is translucent and may be displayed in front of a light source.

### BACKGROUND OF THE INVENTION

1. Field of the Invention

This invention relates to removable memory cartridges and more particularly relates to removable memory cartridges that display an image.

2. Description of the Related Art

Researchers and parents alike are concerned about the amount and quality of sleep children and infants are currently receiving. Research suggests that sixty-nine percent of children suffer from sleep-related disorders. Moreover, the large number of children having difficulty sleeping further indicates that the majority of parents are loosing sleep as well. When children are restless or emotional and require frequent parent intervention throughout the night, both parents and children suffer.

Experts offer many suggestions to help children get more sleep. Establishing a pre-bedtime routine and reading books to children are two suggestions frequently offered to troubled parents to alleviate bedtime struggles. In addition, providing a sleep-conducive environment and placing infants on their backs to sleep have also gained credibility as appropriate measures for good health and for establishing healthy sleeping patterns.

Furthermore, children's lamps and night lights are known to provide comfort to infants and young children. In certain instances, a small light placed near a child's bed calms the child who is afraid of the dark or afraid of being alone. Other children are lulled by soft music, the mother's voice, a recorded heartbeat, or the like. Light and sound can be used to create a soothing atmosphere that brings peace and security to a child. For some children, selected nightlights and ambient sound can be part of a healthy nighttime routine.

While decorative night lights, lamps, recorded music and the like can provide an immediate comfort to a child, these electronic devices typically fail to provide an intermediate interaction level with the user. In other words, the devices typically do not sense or respond to the child's need. Generally, when a child is stirring or upset before bedtime or during the night, parents must go to the child to comfort and reassure the child; however, parents typically do not want to get up repeatedly throughout the night. Thus, an intermediate level of interaction to respond to and comfort a child may reduce the number of times a parent must visit a child having difficulty sleeping.

In addition, known characters, such as cartoon characters or the like, may also provide familiarity to the child. Consistency and predictability can contribute to developing healthy habits and emotional security.

From the foregoing discussion, it should be apparent that a need exists for an apparatus and system that encourages children to develop healthy sleeping patterns. Beneficially, such an apparatus and system would sense the presence of a person, such as a child, and direct an audible message to the person. The audible message would preferably provide comfort, direction and/or companionship to a user as an interactive response to the sensor event. As a result, the user or child may receive a positive response that facilitates falling back to sleep or calming the child.

### SUMMARY OF THE INVENTION

The present invention has been developed in response to the present state of the art, and in particular, in response to the problems and needs in the art that have not yet been fully solved by currently available children's toys, media players or night lights. Accordingly, the present invention has been developed to provide an apparatus and system for sensing a person and displaying an image in conjunction with a removable memory cartridge that overcome many or all of the above-discussed shortcomings in the art.

The apparatus for displaying an image, in one embodiment, includes a housing configured to enclose a memory device for storing data content and a protrusion extending from the housing, the protrusion configured to display an image. The apparatus may further comprise an interface to connect the memory device to a base unit. In certain embodiments, the apparatus comprises a removable memory cartridge that corresponds to the base unit.

In one embodiment, the protrusion is translucent and may be displayed in front of a light source. The protrusion may be a lens and may function similar to a light cover. In certain embodiments, a lip on the protrusion facilitates mounting the removable memory cartridge to the corresponding base unit.

In one embodiment, the content data is an audible message. In a further embodiment, the content data comprises an audible story. The image on the protrusion may be related to the content stored on the memory device. For example, the image may be an illustration related to an audible story stored on the memory device. The image may facilitate identifying the content data stored on the memory device.

A system of the present invention is also presented to display an image in conjunction with a removable memory cartridge. The system may be embodied in an audible lamp or light source with a removable memory cartridge. In particular, the system, in one embodiment, includes a removable memory cartridge comprising a housing configured to enclose a memory device and a protrusion extending from the housing, the protrusion configured to display an image; a base unit comprising a microcontroller that accesses content data stored on the memory device; and an interface that connects the memory device with the base unit. In one embodiment, the base unit includes one or more sensors that detect a sensor event and facilitate sensing a person, such as a child. The base unit may further comprise a speaker for transmitting an audible message and may facilitate transmitting the audible message in response to the sensor.

In certain embodiments, the base unit also includes a light source that is configured to display the image on the protrusion. The protrusion may be a transparent lens, and the light source may comprise a Light Emitting Diode (LED). The content data stored on the memory device may comprise an audible message. In certain embodiments, the light source is configured to pulsate reactive to the audible message.

The system, in one embodiment, may further include a docking unit that provides an interface for docking the base unit. The docking unit may include a memory device comprising rewritable memory and a microphone connected to a microcontroller. The microcontroller may enable creation of a customized audible message and storage of the customized audible message on the memory device. The docking unit may further comprise an enclosure for housing the memory device and the microphone. In one embodiment, the docking unit includes a light projector for projecting light onto a surface.

The docking unit may rely on mechanisms of the base unit for functionality in certain embodiments. For example, the docking unit may respond to base unit controls. Furthermore, the customized audible message stored on the memory device of the docking unit may be transmitted via the speaker of the base unit.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention senses the presence of a person, such as a child, and directs an audible message to the person. The audible message may provide comfort, direction and/or companionship to a user as an interactive response to a sensor event. In another embodiment, the present invention enables the user to view an image related to the content stored on a removable memory cartridge. In addition, the image may be viewable when the memory cartridge is inserted into the base unit and may enable the user to easily determine the stored contents. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a perspective view illustrating one embodiment of a removable memory cartridge with an image displayed on a protrusion in accordance with the present invention;

FIG. 1B is a perspective view illustrating the back of the removable memory cartridge of FIG. 1A;

FIG. 2 is a perspective view illustrating one embodiment of an audible story lamp with a removable memory cartridge in accordance with the present invention;

FIG. 3 is a perspective view illustrating the back of the audible story lamp of FIG. 2;

FIG. 4 is a schematic block diagram illustrating one embodiment of a display system in accordance with the present invention;

FIG. 5 is a perspective view illustrating one embodiment of an audible story lamp docked on a docking unit in accordance with the present invention;

FIG. 6 is a perspective view illustrating one embodiment of a docking unit in accordance with the present invention; and

FIG. 7 is a perspective view illustrating one embodiment of a storage holder for storing a memory cartridge in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to give a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

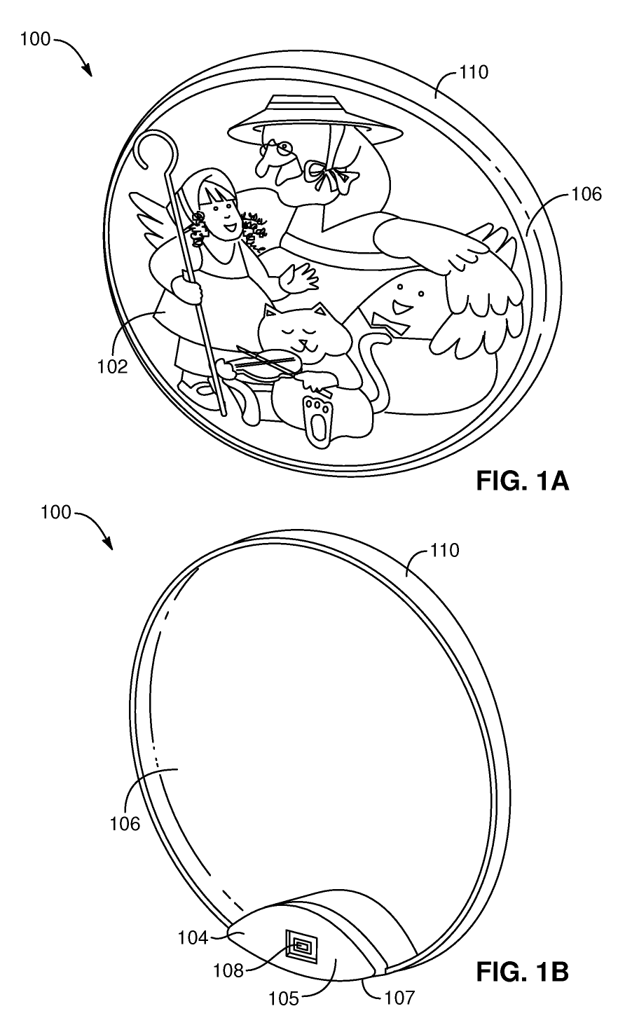

FIGS. 1A and 1B depict one embodiment of a removable memory cartridge 100 that displays an image 102. The removable memory cartridge 100, as depicted, includes a housing 104, a protrusion 106, and an interface 108 and is configured to correspond to a base unit (not shown), such as an electronic device, computing device, hand-held device, or the like.

Removable memory cartridges 100 typically comprise a memory device (not shown) encased in a protective housing 104. The housing 104 generally provides for and/or accommodates an interface 108 that enables a base unit, computing device, or the like to access data stored on the encased memory device. Removable memory cartridges 100 are commonly used as a portable form of data storage. The memory device is usually recordable and may comprise read-only memory (ROM) suitable for storing software programs or the like; or rewritable memory ideal for data storage or backup.

Removable memory cartridges 100 have gained popularity in the last decade as memory capacities have improved, providing greater storage densities on smaller storage media. Common types of removable memory cartridges 100 include, but are not limited to, video game cartridges, jump drives, memory sticks, memory cards, disks, and the like. The removable memory devices provide increased functionality and versatility to the base unit in most instances.

In one embodiment, the housing 104 is made from plastic and encloses the memory device. The housing 104 may be shaped to correspond to the base unit in certain embodiments. Alternatively or in addition, the housing 104 may simply facilitate connecting the interface 108 to the base unit. For example, the housing 104 may facilitate inserting the interface 108 into the base unit, yet the protrusion 106 may not correspond to the base unit.

In the depicted embodiment, the housing 104 is a rounded chamber with a flat face 105 that contacts the surface of a corresponding base unit. The interface 108 is embedded within the housing 104 and is accessed through the housing face 105. The protrusion 106 extends above the housing 104 in a continuous arc starting from the bottom 107 of the housing 104, and includes an integrated, unbroken display surface for displaying the image 102. In one embodiment, the protrusion 106 is an extension of the housing 104.

The housing 104 may further provide a friction fit to mount the memory cartridge 100 to the base unit in certain embodiments. In the depicted embodiment, the protrusion 106 creates a thin, circular, protruding lens that comprises a lip 110 to frictionally engage the base unit and to retain the housing 104.

Alternatively or in addition, the protrusion 106 may include a fastener or connecting device to facilitate connecting the protrusion 106 and/or the housing 104 to the base unit. Connecting devices may include, but are not limited to, latches, hooks and loops, release mechanisms, and the like. Those of skill in the art will recognize that various connections or connecting devices may be employed to connect the memory cartridge 100 to the base unit.

In a further embodiment, the protrusion 106 comprises a translucent lens 106 configured to be displayed in front of a light source. As a result, the light source may illuminate the image 102 displayed on the protrusion 106, similar to the light cover of a night light, lamp, children's toy, or the like. Furthermore, the light source may be configured to pulsate or flash, thereby creating an illusion of motion in conjunction with the image 102.

The protrusion 106 may be made of a variety of materials, including but not limited to plastic, and may be formed in various shapes. The protrusion 106 may be shaped geometrically like a diamond, pyramid, and the like, or shaped to resemble a known object or character, such as a cartoon. In addition, the image 102 surface may protrude outward, curve inward, or be textured or the like. Furthermore, the protrusion 106 may extend any suitable length and from any part of the housing 104. Those of skill in the art will recognize that the protrusion 106 may be shaped distinctively for various reasons or objectives, and is not, therefore, limited to the illustrated or disclosed embodiments.

In certain embodiments, the protrusion 106 may be hingedly connected to the housing 104. As a result, the housing 104 and/or interface 108 may fold into the protrusion 106, thereby forming a compactable memory cartridge 100 for easier storage and portability.

In certain embodiments, the image 102 displayed on the protrusion 106 relates to the content data and may facilitate identifying the content data stored on the memory device. For example, the content data on the memory device may comprise an audible message containing a collection of mother goose nursery rhymes. Accordingly, the image 102 may display mother goose and characters from the nursery rhymes as illustrated.

Alternatively or in addition, the content may include, but is not limited to, movies, video games, audio books, music, or the like. Similarly, the image 102 may comprise a corresponding scene from the movie, a character/scene from the video game, an illustrated book cover, or a design corresponding to the music, for example. The image 102 or the content data stored on the memory device, so long as the base unit is able to access and/or write content data to the memory device.

In certain embodiments, the content data may contain multiple audio messages, such as multiple children's stories, for example. Accordingly, the image 102 may comprise numerous characters or scenes from the stories arranged in the order of presentation. In one embodiment, the protrusion 106 may be placed in front of an array of LED lights. The LED lights may be programmed to selectively light up a specific image 102 that corresponds to the content of an audible message. Alternatively, the protrusion 106 may be configured to rotate to place the image in front of a light source. In one embodiment, the protrusion revolution or the activated light may be timed with the running time of the audible message.

Those of skill in the art will recognize that the image 102 may comprise any number or types of visual displays. For example, the image 102 may comprise alphabetical characters, logos, illustrations, designs, or the like. In one embodiment, the image 102 may be printed on an adhesive label or the like and affixed to the protrusion 106. Alternatively, the image 102 may be formed into the protrusion 106 as a molded image or the like. In one embodiment, the protrusion 106 may comprise a label for writing information relative to data stored on the removable memory cartridge 100. In a further embodiment, projected light may form an image 102 on the protrusion 106. Specific examples are disclosed for illustrative purposes only and do not limit the scope of the invention.

The interface 108 may provide a connection between the memory device and the base unit. In one embodiment, the interface 108 is a Universal Serial Bus (USB) connection. Alternatively, the interface 108 may be any connection interface suitable for enabling one or more base units to access stored content data. In certain embodiments, the interface 108 enables the removable memory cartridge 100 to store content data downloaded from the internet.

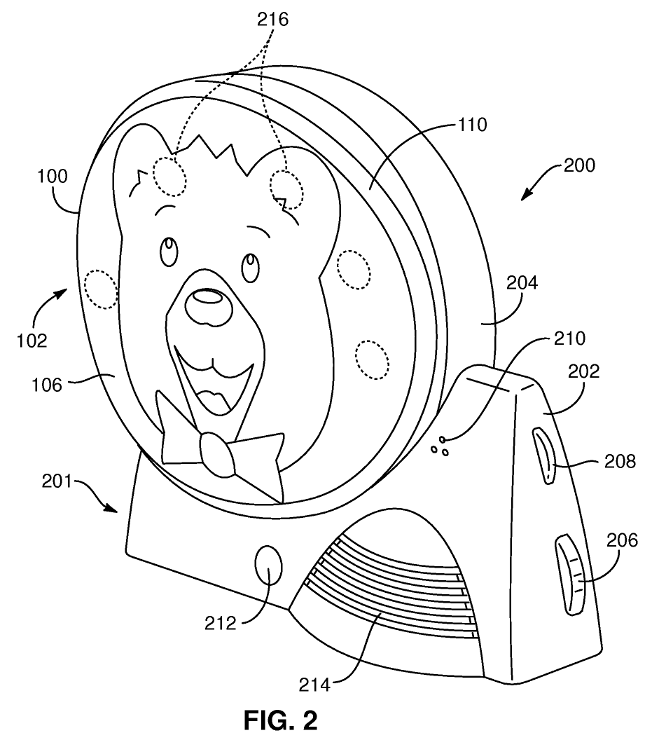

FIG. 2 illustrates one embodiment of a base unit 200 with an interfacing removable memory cartridge 100. In certain embodiments, the base unit 200 comprises an audible story lamp. The base unit 200, as depicted, includes an enclosure 201, a base 202, an extension 204, a 3-way switch 206, a volume control 208, an audio sensor 210, a light sensor 212, and a speaker 214. In the depicted embodiment, a light source 216, such as an array of energy-efficient LED lights 216, for example, is embedded in the extension 204 and is concealed behind the lens 106, or protrusion 106. Consequently, the base unit 200 may function as a lamp and/or a night light, and the protrusion 106 of the removable memory cartridge 100 effectively functions as a light cover.

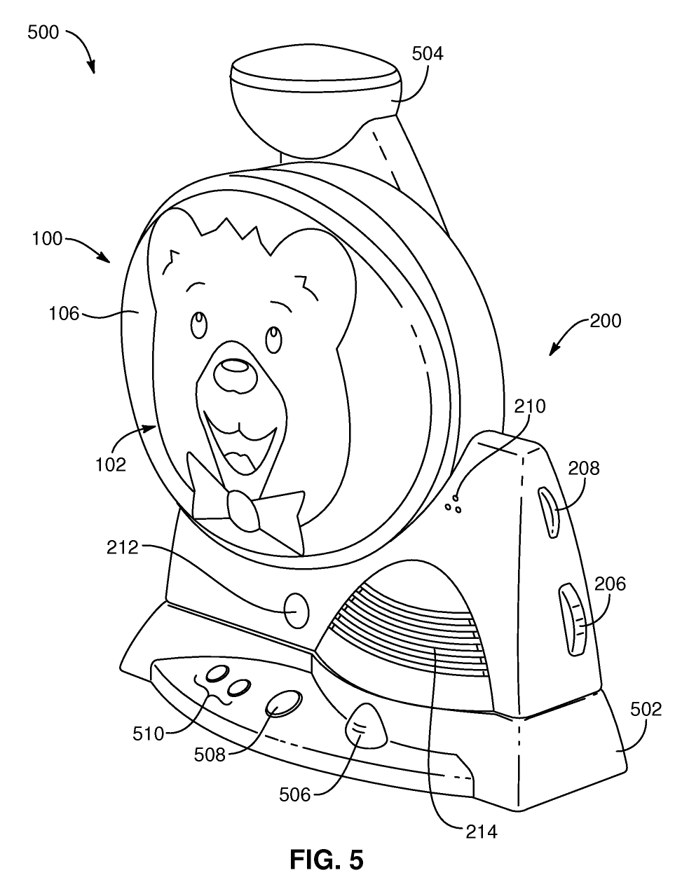

The base unit 200 may include an enclosure 201 for enclosing a microcontroller (not shown), a circuit board, and the like. In the depicted embodiment, the base 202 embodies the controls and sensors that functionally control the input/output of the base unit 200. In addition, the base 202 may include an interface (not shown) for connecting the base unit 200 to a docking unit (See FIG. 5), which may increase the base unit's functionality. In certain embodiments, the enclosure 210 is made of plastic. Alternatively, the enclosure 201 may be made from any suitable material.

The extension 204 may provide an interface (not shown) for connecting the removable memory cartridge 100 to the base unit 200. The extension 204 may correspond to the shape of the memory cartridge 100 in certain embodiments. As mentioned, the extension 204 may further provide a light source 216 for illuminating the image 102 of the memory cartridge 100. In one embodiment, the light source 216 comprises a plurality of piped LED lights, which may be disposed on the extension 204 to accent the image 102 on the lens 106. The lights may be placed in a circular pattern as illustrated. Alternatively, the lights 216 may be spaced irregularly for a lighting effect. Those of skill in the art will recognize that the light source 216 may comprise a variety of lights and various arrangements. Furthermore, the light source 216 may be activated by one or more sensors or controls.

In one embodiment, the audio sensor 210 and/or the light sensor 212 triggers a sensor event, which in turn causes a response, such as a light display and/or an audible response. In a contemplated embodiment, one or more audible messages are digitally stored on the removable memory cartridge 100 and are playable through the speaker 214. The audible message may comprise an audio recording of a storyteller telling a story. In addition, the image 102 on the lens 106 may correspond to the chosen story. In one embodiment, the removable memory cartridge 100 digitally stores a twenty-minute audible story and the image 102 functions more or less as a book cover.

Furthermore, the LED lights 216 may be tuned to the audible message or to emitted sounds. The lights 216 may pulsate or twinkle, randomly or in a pattern, to give the illusion of life, motion, and speech. In one embodiment, a theater-production storytelling digitally stored on the memory cartridge 100 may include, but is not limited to, music, sound effects, children's voices, singing, and character voices. The light pattern may react differently for each of the different sounds. For example, the distinct voices may cause the lights to dim or brighten, the music may pulse with a beat or alternate with high and low pitches, prominent sound effects may cause the lights to flash, and singing may engage all of the lights, or the lights may appear to dance. Alternatively, the lights may flash randomly, disconnected from the variations in the audible message. In an alternative embodiment, the lights may be timed.

In one embodiment, the story content data stored on the memory device includes music to sooth and entertain a child. The child may trigger a sensor event by talking or, in some instances, by crying. The music may start, and a storyteller may begin talking to the child. The storyteller may continue to tell a story animated with the character voices and sound effects. Then the story may end with more music. In certain embodiments, classical music may be selected to increase the child's intellectual development. Alternatively, a lullaby played at the end may encourage the child to go to sleep. Furthermore, the audible message may include a coder familiar to a series of recorded stories. For example, a theme song, common character, or the like may introduce a story, thereby providing a familiar link to every story in the series.

In one embodiment, the content may be designed to encourage children to go to sleep. Consequently, the removable memory cartridge 100 may function as a bedtime story. In a further embodiment, a proprietary website provides downloadable content, such as stories, lullabies, soothing sounds, etc., that may be downloaded and stored on either the removable memory cartridge 100 or the base unit 200. The downloaded content may correspond to an image 102 on the lens 106 in certain embodiments. In one embodiment, the downloaded content is wirelessly transmitted to a memory device.

The controls 206, 208 may facilitate manually controlling the base unit 200 input/output response. In one embodiment, the three-way switch 206 enables the user to select between OFF, AUTO, and ON. In the OFF position, no response is provided. In the AUTO position, the audible message and the light source may be triggered by a combination of the light sensor and the audio sensor: for example, a low level of light may trigger the light source, while a detected audio level may trigger the audio response. In the ON position, the light source 216 may be illuminated, like a night light or lamp, while the audio sensor triggers the audible message.

The volume control 208 may facilitate adjusting the volume of the audible message. If no audible message is desired, the volume may be turned off to prevent emitting sound. On the other hand, the volume may be adjusted to a desired listening level. The speaker 214 may be a mid-range speaker with the minimum quality of a standard clock radio. In a contemplated embodiment, the speakers 214 enable the theater-production storytelling to be presented with clear and distinct sounds.

In one embodiment, the base unit 200 may become part of a nightly bedtime ritual. For example, a library of stories may be available, either downloaded through the internet or through the removable memory cartridges 100, and the user may select a story or the like to be activated by the sensors. A parent may leave the room and turn off the light to activate the base unit 200 for the child. Subsequently, the child may speak to activate the bedtime story. The story may be calming to the child and may further encourage the child to develop important learning skills, such as listening and creativity. In certain embodiments, the content of the removable memory cartridge 100 or the like may be refined and developed to engage the child's interest and to encourage the child to enjoy and anticipate bedtime.

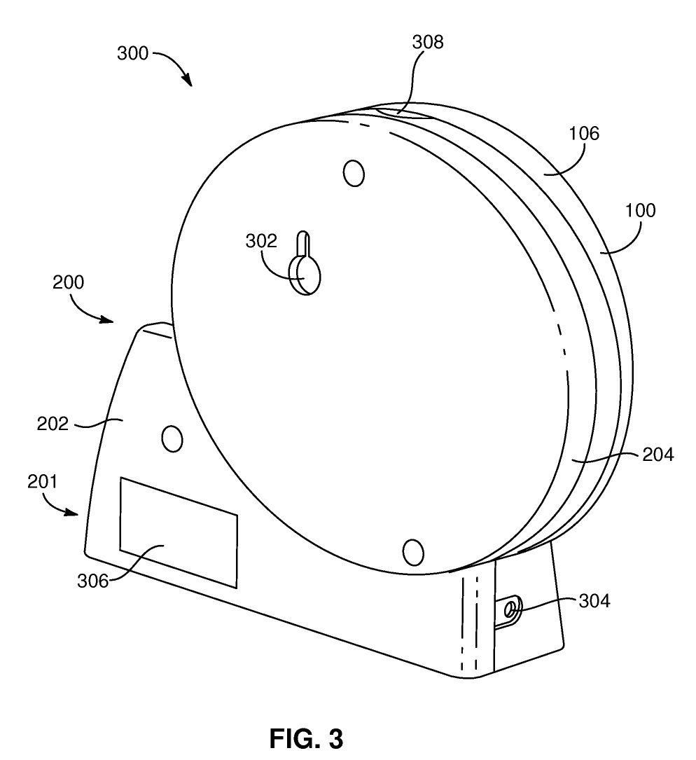

FIG. 3 illustrates one embodiment of a rear view 300 of the base unit 200. The base unit 200 may further include one or more mechanisms 302 to enable mounting the base unit 200 to a wall or the like. In the depicted embodiment, the extension 204 has a flat back surface and includes a formed notch 302 for receiving a nail, hook, or the like. Alternatively or in addition, the base unit 200 may be mounted with an adhesive, such as 3M® Command Adhesive or the like. In the depicted embodiment, the base unit 200 has a flat bottom that enables the base unit 200 to rest on a support surface.

The base unit 200 may further include a power supply 304 for powering the electronic mechanisms. In certain embodiments, the base unit 200 includes a power input 304 or jack 304 for receiving electrical power through an AC/DC adapter cord. Alternatively or in addition, the base unit 200 may further provide a battery chamber 306 formed within the housing 201 for receiving batteries. In one embodiment, the battery chamber 306 accommodates 9-volt batteries and may function as a standby power source, such as during a power outage, for example. Thus the story lamp may continue to function as a comfort to a child and to light a room.

The base unit 200 may further include an indentation 308 or the like to facilitate removing the removable memory cartridge 100 from the extension 204 of the enclosure 201. In the depicted embodiment, the indention 308 functions as a finger grip to remove the lens 106 from the extension 204. Those of skill in the art will recognize that the enclosure 201 of the base unit 200 may comprise many forms to support and/or display the protrusion 106 and to access the memory device of the removable memory cartridge 100. The base unit 200 is not, therefore, limited to the illustrated embodiment.

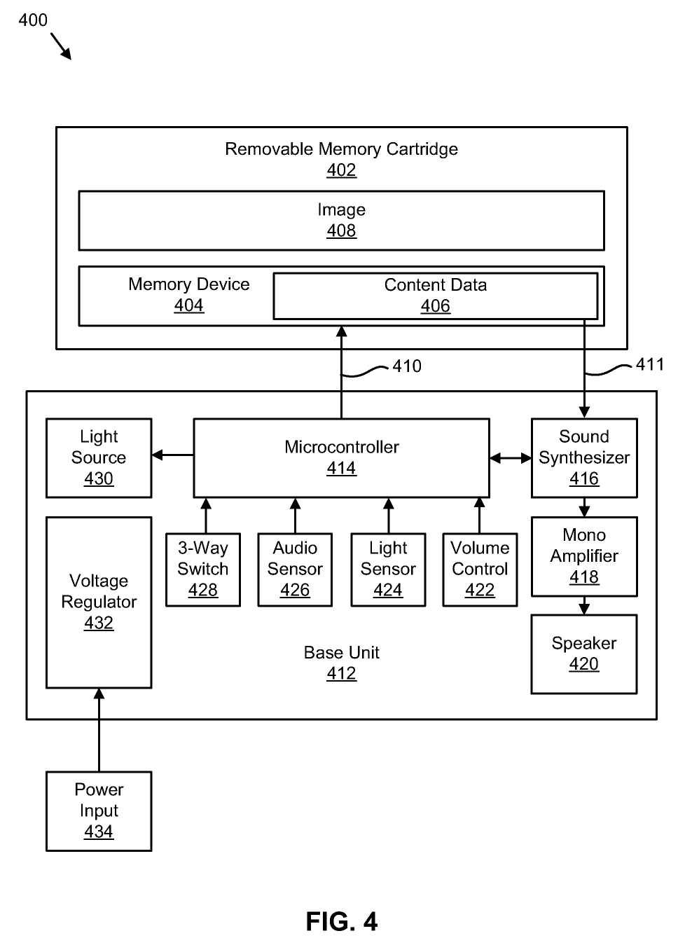

FIG. 4 illustrates one embodiment of a display system 400 for displaying an image 408 in conjunction with a removable memory cartridge 402. The removable memory cartridge 402 may comprise a memory device 404, content data 406, an image 408 displayed on a protrusion, and an interface 410 to interface the memory device 404 with a microcontroller 414 of a base unit 412.

The base unit 412 may comprise a microcontroller 414, a sound synthesizer 416, a mono amplifier 418, a speaker 420, a volume control 422, a light sensor 424, an audio sensor 426, a 3-way switch 428, a light source 430, a voltage regulator 432, and a power input 434. The base unit 412 provides the logical components necessary to control the input and output. In certain embodiments, the base unit 412 may function similarly to the audible story lamp described above.

The removable memory cartridge 402 may correspond to the base unit 412 and provides the memory device 404 and the content data 406 for content output. The memory device 404 may be recordable and may be configured to store content data 406 in a digital format.

In one embodiment, the memory device 404 comprises Read-Only Memory (ROM). One example of ROM memory may include Production Programmed Read Only Memory (P2ROM) available from Oki® Semiconductor, Corporate Headquarters, 785 North Mary Avenue, Sunnyvale, Calif. 94085. P2ROM memory is currently implemented in hand-held video games and may provide several advantages over other types of memory devices 404. First, P2ROM memory is manufactured without masks and thus has no associated masking charges, thereby rendering low production costs. Second, the manufacturing process to program content data 406 and to test the memory devices 404 may occur at the production site and may be received within two weeks of ordering the memory device 404, which is a relatively rapid production time. Third, the P2ROM memory may produce quality audible messages for transmission to the speaker 420.

In another embodiment, the memory device 404 comprises rewritable memory. For example, rewritable flash memory provides programmability and may enable the user to renew content data 406 stored on the memory device 404. In one embodiment, an online library provides content data 406 that may be downloaded and stored on the removable memory cartridge 402. In addition, rewritable memory may further allow a user to create personalized content data 406, which may be accessed by the base unit 412.

Those of skill in the art will recognize that the memory device 404 may be selected from various types of memory and memory devices that may or may not be currently available in the market. Thus, the present invention is not limited to the disclosed embodiments.

The removable memory cartridge 402, in certain embodiments, further includes the interface 410 to provide a connection and/or a communication link between the memory device 404 and the base unit 412. More specifically, the interface 410 may provide a connection between the memory device 404 and the microcontroller 414 to enable the microcontroller 414 to access content data 406 stored on the memory device 404. In certain embodiments, another interface 411 may be provided to connect the content data 406 to the sound synthesizer 416. In one embodiment, the interface 410 comprises a USB connection.

The microcontroller 414 may receive input from the volume control 422, the light sensor 424, the audio sensor 426, and the 3-way switch 428 to determine when to activate the light source 430 and/or the sound synthesizer 416. In certain embodiments, the microcontroller 414 may access an internal memory device (not shown), alternatively or in addition to the memory device 404 of the removable memory cartridge 402. In alternative embodiments, the microcontroller 414 may additionally access a remote memory device or a memory device in a docking unit.

In one embodiment, the microcontroller 414 is a forty pin microchip PIC 16F914 manufactured by Oki® Semiconductor. Oki® Semiconductor also produces a sound synthesizer 416 that may be compatible with the referenced microchip and P2ROM memory. The synthesizer 416 may transmit the content data 406 to the mono amplifier 418 and subsequently to the speaker 420.

The power input 434 may comprise an AC/DC adapter cord and power jack, as mentioned above, or another form of electrical power. The voltage regulator 432 maintains a level amount of voltage supplied to the other electrical components and prevents damage due to power surges, spikes, and brownouts.

The display system 400 provides a relatively inexpensive and simple manner to display an image in conjunction with content data 406 stored on a removable memory cartridge 402. The content data 406 may be accessed and transmitted to the speaker 420 relative to the constraints determined by the user. In addition, the content data 406 may be sensor activated. Moreover, the content data 406 and the image 408 may be altered by interchanging various removable memory cartridges 402.

FIG. 5 illustrates one embodiment of a docking unit 500 for docking the base unit 200. The docking unit 500, as depicted, includes a base 502 and a light projector 504. The base 502 may include an interface (not shown) for connecting the docking unit 500 to the internal components of the base unit 200.

The docking unit 500, in one embodiment, is an accessory unit for augmenting the capabilities of the base unit 200. For example, the docking unit 500 may function as a “recording studio” that includes logical components for recording and playing back audio messages. The docking unit 500 may include a microcontroller (not shown), a microphone 506, a record button 508, and control buttons 510. To create a customized audio message, in certain embodiments, the base unit 500 may further include an analog to digital converter and a writable memory device, such as Random Access Memory (RAM) for storing the digital message. In certain embodiments, the ability to record may function similar to messages recorded on a digital answering machine as is known in the art.

In a contemplated embodiment, instructions may be provided for recording a story or the like in the mother's voice, to be used as an intermediate response to comfort a child. For example, the story may correspond to the image 102 on a lens 106. Alternatively, the lens 106 may be personalized to correspond to a customized recording. As a result, a sensor event may activate transmission of a customized audible story or message, and the image 102 may relate to the audible transmission. In one embodiment, the docking unit 500 enables the user to choose between transmitting a production pre-recorded story/message or the customized story/message when the sensor event occurs. The docking unit 500 enables the user to customize use of the base unit 200 in certain embodiments.

In one embodiment, the docking unit 500 relies on the mechanisms incorporated in the base unit 200. For example, messages recorded on the docking unit 500 may be playable through the speaker 214 of the base unit 200. Furthermore, the controls 208, 206 and the sensors 210, 212 may control and/or trigger the content data or audible message(s) stored on the docking unit 500.

In one embodiment, the docking unit 500 is intended to entertain or comfort infants who respond positively to the mother's voice. Consequently, the mother may record a soothing message that may be transmitted to the child when the child cries or activates one or more sensors of the base unit 200. The light projector 504, in certain embodiments, further provides an overhead light or image projection to sooth the infant and to encourage the infant to sleep on her back.

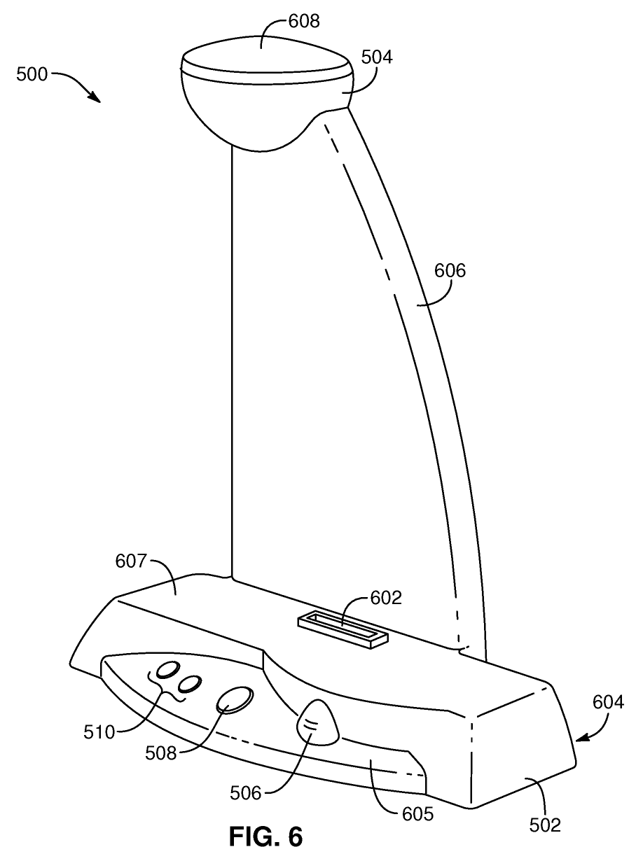

FIG. 6 illustrates the docking unit 500 in greater detail. As illustrated, the docking unit 500 includes an interface 602 for docking the base unit 200. In addition, the docking unit 500 may comprise a base 502, an enclosure 604, an extension 606, a light projector 504, and a projector lens 608. As illustrated in FIG. 5, the docking unit 500 may be configured to support the base unit 200.

The enclosure 604 may include the base 502, the extension 606, and the light projector 504. Alternatively, the base 502, extension 606, and light projector 504 may be comprised of separate components. The base 502 may include a rectangular box-like enclosure 604 for housing internal electrical components. The shape of the base 502 may correspond to the shape of the base unit 200 for aesthetic purposes. A fin-like control panel 605 may extend horizontally from the base 502 to enable the user to select function options and to easily view the control buttons 508, 510. Various control functions may include, but are not limited to, record, erase, play, select an audio message, select a mode, designate the light source, etc. As mentioned, the base 502 may further include the interface 602 for connecting to the logic of the base unit 200. The interface 602 may be centrally disposed on a flat support surface 607.

The extension 606 may extend vertically to support the light projector 504, which may project light onto a surface. In the depicted embodiment, the light is projected onto the ceiling. Consequently, the extension 606 extends the length of the base unit 200 to position the projector 504 above the base unit 200. The extension 606 may be alternatively configured to adjust the light or to project the light onto a different surface, such as a wall. In one embodiment, the extension 606 may extend telescopically to adjust the focus of a projected image and/or to adjust the size. Alternatively or in addition, other mechanisms may be used to adjust or focus the image.

In certain embodiments, the light may be projected through a lens 608 to enhance the light display. The lens 608 may be interchangeable and may include one or more images. The image may be a simple image to preserve the display quality. In certain embodiments, the projected light may function as a night light.

In one embodiment, the image corresponds to the content data stored on one or more of the memory devices disposed either within the docking unit 500, the base unit 200, or the removable memory cartridge 100. In one embodiment, the image may be an illustration from a story and may correspond to the image 102 displayed on the protrusion 106. In addition, the lens 608 may revolve to add motion to the image, or to progressively highlight one of a series of images. In another embodiment, a mask (not shown), which may or may not be integral to the lens 608, may block portions of the lens to create light images and/or shadows on the surface. The mask may revolve to block portions of the lens 608 or the light source.

The projected light(s) may be configured to flash or to alternate brightness. In certain embodiments, the light(s) may be colored. Alternatively, the lens 608 may be colored to project a colored light. A flashing pattern may be determined by the base unit 200 in one embodiment. For example, the light source 216 may be configured to change light patterns reactive to the audio output. The light projector 504 may consequently adapt the reactive light pattern to display the projected light similarly. In one embodiment, the light projector 504 creates a light show timed with music and/or voice. In one embodiment, the light projector 504 is a formed bowl with one or more piped LED lights disposed within the bottom of the bowl and facing outward toward the top of the bowl.

The docking unit 500 further increases the user's ability to customize the input and output associated with the base unit 200 and the removable memory cartridge 100. The control panel 605 and projector lens(es) 608 provides the user with viewing and recording/listening options, while the extension 606 and light projector 504 provide a projected light display.

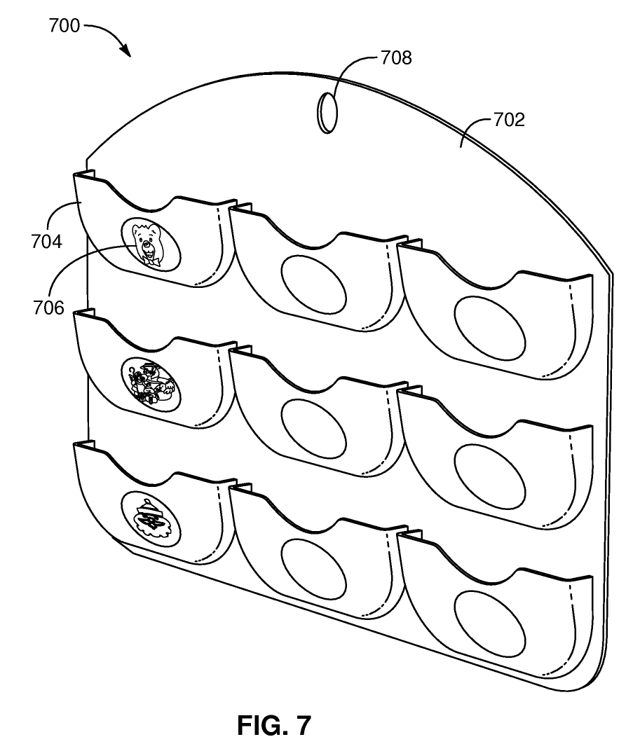

FIG. 7 illustrates one embodiment of a storage holder 700 for storing one or more removable memory cartridges 100. The storage holder 700 may comprise a support 702, one or more compartments 704, and an identifier 706. Certain embodiments may further include a hole 708 or the like for hanging the storage holder 700. The storage holder 700 may be made of a solid material, such as plastic or wood, or a supple material such as vinyl or canvas, for example. In one embodiment, the support 702 and the compartments 704 are made from a durable, foldable fabric. The storage compartment 704, in one embodiment, is shaped as a pocket that corresponds to the shape of a removable memory cartridge 100. Consequently, individual cartridges 100 may be stored in a corresponding compartment 704.

In addition, the storage holder 700 may include an identifier 706, such as a story decal or the like, to identify the content data stored on a certain memory device. As a result, multiple memory cartridges 100 may be organized and stored together in designated compartments. The storage holder 700 may be particularly useful for data content used to create a series, such as a series of stories, for example.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for displaying an image in conjunction with a removable memory:
cartridge, the apparatus comprising:
a housing configured to enclose a memory device, wherein the memory device is configured to store content data;
an interface configured to connect the memory device with a base unit; and
a transparent lens extending from the housing, the transparent lens configured to display an image in front of a light source and wherein the image is related to content data stored on the memory device.

2. The apparatus of claim 1, wherein the content data comprises an audible message.

3. The apparatus of claim 2, wherein the content data comprises an audible story and the image comprises an illustration related to the audible story.

4. The apparatus of claim 1, wherein the memory device comprises ROM memory.

5. The apparatus of claim 1, wherein the memory device comprises rewritable memory.

6. The apparatus of claim 1, wherein the memory device comprises Production Programmed Read Only Memory (P2ROM).

7. The apparatus of claim 1, wherein the transparent lens further comprises a lip to facilitate mounting the removable memory cartridge to the base unit.

8. A system for displaying an image in conjunction with a removable memory cartridge, the system comprising:
a removable memory cartridge comprising,
a housing configured to enclose a memory device, wherein the memory device is configured to store content data; and
a protrusion extending from the housing, the protrusion configured to display an image;
a base unit comprising a microcontroller, the microcontroller configured to access content data stored on the memory device; and
an interface configured to connect the memory device with the base unit.

9. The system of claim 8, wherein the protrusion comprises a translucent lens configured to be displayed in front of a light source.

10. The system of claim 9, wherein the base unit further comprises a light source configured to illuminate the image displayed on the translucent lens.

11. The system of claim 10, wherein the light source comprises an LED light.

12. The system of claim 10, wherein the image is related to the content data stored on the memory device and the content data comprises at least one audible message.

13. The system of claim 12, wherein the base unit further comprises a speaker configured to transmit the at least one audible message.

14. The system of claim 13, wherein the light source is configured to pulsate reactive to the transmitted audible message.

15. The system of claim 13, further comprising a docking unit configured to provide an interface for docking the base unit, the docking unit comprising,
a memory device comprising rewritable memory; and
a microphone connected to a microcontroller, the microcontroller configured to enable creation of a customized audible message and to store the customized audible message on the memory device.

16. The system of claim 15, wherein the docking unit further comprising an enclosure configured to house the memory device and the microphone.

17. The system of claim 16, wherein the docking unit further comprises a light projector attached to the enclosure, the light projector configured to project light onto a surface.

18. The system of claim 17, wherein the customized audible message is configured to be transmitted from the speaker of the base unit.

19. The system of claim 12, wherein the base unit further comprises at least one sensor configured to detect a sensor event, and wherein the microcontroller is configured to initiate communication of the audible message in response to a sensor event detected by the sensor.

20. The system of claim 8, further comprising a storage holder configured to store a plurality of removable memory cartridges.

21. An apparatus for displaying an image in conjunction with a removable memory cartridge, the apparatus comprising:
a housing configured to enclose a memory device, wherein the memory device comprises Production Programmed Read Only Memory and is configured to store content data, wherein the content data comprises an audible story;
an interface configured to connect the memory device with a base unit; and
a transparent lens extending from the housing, the transparent lens configured to display an image related to the audible story in front of a light source.
